(19) United States
(12) Patent Application Publication
(10) Pub. No.: US 2007/0123599 A1
(43) Pub. Date: May 31, 2007

(54) Grafted polyether copolymers and the use thereof for stabilizing foams

(75) Inventors: Christian Eilbracht, Herne (DE); Jutta Esselborn, Essen (DE); Sascha Herrwerth, Essen (DE); Peter Schwab, Essen (DE)

Correspondence Address: Leopold Presser, Scully, Scott, Murphy & Presser, 400 Garden City Plaza, Garden City, NY, 11530, US

(73) Assignee: Goldschmidt GmbH, Essen (DE)

(21) Appl. No.: 11/593,733

(22) Filed: Nov. 7, 2006

(30) Foreign Application Priority Data
Nov. 25, 2005 (DE) 10 2005 056 246.9

(51) Int. Cl. C08J 9/00

(52) U.S. Cl. 521/134

(57) ABSTRACT

The invention relates to the use of substantially silicon-free polymers, obtainable by free radical graft polymerization of up to 50 parts by weight of at least one ethylenically unsaturated monomer (A) in the presence of at least 50 parts by weight of at least one polyether (B), as stabilizers for the preparation of PU and/or PI foams.

### FIELD OF THE INVENTION

The present invention relates to foam stabilizers which are free of silicon atoms and to their use for the preparation of polyurethane foams and/or polyisocyanurate foams.

### BACKGROUND OF THE INVENTION

Rigid polyurethane foams are used in various applications, inter alia for thermal insulation, for energy absorption and for sound absorption. The properties of the foam formed depend, in particular, on the structure and the chemical composition of the foam stabilizer used. Foam stabilizers are used as process auxiliaries in the industrial production of polyurethane foams. Foam stabilizers emulsify the raw materials used, stabilize the foam during the production process and permit the formation of a homogeneous foam having a uniform pore structure, desired cell fineness and open-cell character.

In general, polysiloxane-polyoxyalkylene block copolymers are used as foam stabilizes. These stabilizers are highly effective and can be adapted to the foaming system and the foaming process by a suitable choice of the structure and of the composition. However, in polyurethane foams, the siloxane content of these block copolymers leads to a substantial deterioration in the fire behavior owing to increased flammability. However, owing to the method of preparation, these silicone-based stabilizers always contain a considerable proportion of volatile, cyclic and low molecular weight linear siloxanes which can exhibit undesired effects, such as a significant contribution to emission (“fogging”—“VOC”), during the subsequent use of the foam.

Furthermore, with the use of organosilicon stabilizers, it was observed that the sure of the foams obtained are poorly wettable, with the result that subsequent surface treatments, such as, for example, coating and the application of a plurality of foam layers, are complicated.

Attempts have therefore been made to prepare silicon-free stabilizes which do not have the disadvantages described above. Si-free foam stabilizers have already been mentioned repeatedly in the literature. In addition to simple surfactants, for example alkoxylated derivatives of nonylphenol (see U.S. Pat. No. 5,236,961), alkoxylated fatty alcohols (see EP-A0 343 463), fatty acid esters and fatty acid amides (see DE-A-195 213 51), polyetherols whose effectiveness is based on the presence of butylene glycol have also been described (see WO-A-95/16721). OH compounds of various functionalities, but also amines (ethylenediamine, ammonia and ethanolamine), are mentioned as initiators.

Also Si-flee are stabilizers based on partially or completely fluorinated compounds, as described, for example, in U.S. Pat. No. 4,356,273.

WO-A-97/14732 describes silicon-flee rigid polyurethane (PU) foams, which, however, are prepared on the basis of already known silicon-free foam stabilizers. DE-A-22 44 350 describes a process for the preparation of silicon-free stabilizers which were prepared by free radical polymerization of N-vinylpyrrolidone, N-vinylpyrrolidone and dibutyl maleate or N-vinylpyrrolidone, dibutyl maleate and vinyl acetate in polyfunctional polyetherpolyols.

DE-A-25 00 017 and U.S. Pat. No. 4,091,030 describe silicon-flee stabilizers which are prepared by free radical polymerization of cyclic, nitrogen-containing monomers (N-vinylamides) and an ester of an unsaturated dicarboxylic acid in polyfunctional polyetherpolyols.

However, silicon-flee foam stabilizers of the prior art have shown emulsion behavior worthy of improvement, in particular, with regard to the uniformity of the cell structures formed. It is therefore an object of the present invention to provide foam stabilizers for PU and/or polyisocyanurate (PI) foams which have a low thermal conductivity and a high fire retardance in combination with a structure which is as fine-cell and uniform as possible and which avoid the disadvantages associated with the emissions of silicone-containing foams.

### SUMMARY OF THE INVENTION

The above mentioned object is achieved, according to the invention, by the use of substantially silicon-free polymers, obtainable by free radical graft polymerization of up to 50 parts by weight of at least one ethylenically unsaturated monomer (A) in the presence of at least 50 parts by weight of at least one polyether (B), as stabilizers in the preparation of PU and/or PI foams.

The free radical graft polymerization is preferably carried out with from 2 to 50 parts by weight, in particular from 5 to 30% by weight, based on the total amount of the starting materials, of monomers A, and from 50 to 98 parts by weight, in particular from 70 to 95% by weight, based on the total amount of starting materials, of polyethers B.

The individual components of the grafted polyethers in each case by themselves, i.e., the polymerized monomer A and the polyether B, do not have a stabilizing effect on PU/PI foams to the extent according to the invention. The invention is therefore based substantially on the surprisingly found synergism of the use according to the invention.

### DETAILED DESCRIPTION OF THE INVENTION

As stated above, the present invention provides substantially silicon-free polymers obtainable by free radical graft polymerization of up to 50 parts by weight of at least one ethylenically unsaturated monomer (A) in the presence of at least 50 parts by weight of at least one polyether (B), as stabilizers in the preparation of PU and PI foams.

The monomers A can be homo- or copolymerized with the use of conventional synthetic methods. For example, these may be solution polymerization, emulsion polymerization, inverse emulsion polymerization, suspension polymerization, inverse suspension polymerization or precipitation polymerization, without the methods usable being limited thereto. In the case of solution polymerization, water and customary organic solvents and the ether derivatives B according to the invention themselves may be used as solvents. The last-mentioned process is, however, preferred.

In principle, it is possible to use, as monomers A, substances which can be polymerized by a reaction initiated by free radicals.

It is particularly preferred, in the context of the invention, if monomers A are present which are selected from the group consisting of the derivatives of acrylic acid and methacrylic acid, vinyl ethers vinyl alcohols, vinyl esters, styrene, derivatives of styrene and mixtures of these monomers.

Suitable unsaturated monomers A are, for example, hydrocarbons (highly preferred) having at least one carbon-carbon double bond, in particular if monomers A are present which are selected from the derivatives of acrylic acid and methacrylic acid of the general formula I
R¹O—C(O)CR²═CHR³ Formula I,
in which
R¹ is a C₁-C₄₀-linear, C₃-C₄₀-branched, aromatic or C₃-C₄₀-carbocyclic, optionally mono- or poly-hydroxyl-substituted hydrocarbon radical, in particular derived from mono- or polyfunctional alcohols having from 2 to about 10 hydroxyl groups, such as ethylene glycol, hexylene glycol glycerol and 1,2,6-hexanetriol, from alcohol ethers, such as methoxyethanol and ethoxyethanol, or from polyethylene glycols,
R² and R³ independently of one another, are selected from the group consisting of:
   —H, C₁-C₈-linear or branched alkyl chains and the methoxy, ethoxy, 2-hydroxyethoxy, 2-methoxyethoxy and 2-ethoxyethyl group.

Further suitable monomers A are vinyl ethers, vinyl alcohols, styrene, derivatives of styrene and mixture of these monomers.

Monomers A, which are selected from the group consisting of styrene, methylstyrene, tert-butylstyrene and other styrene derivatives and from mixtures of these monomers, are preferably present.

Also particularly preferably present are unsaturated monomers A which are selected from the group consisting of vinyl and allyl esters of C₁-C₄₀-linear, C₃-C₄₀-branched or C₃-C₄₀-carbocyclic carboxylic acids, in particular vinyl acetate, vinyl propionate, vinyl neononanoate, vinyl neoundecanoate or vinyl tert-butylbenzoate, and vinyl or allyl halides and mixtures of these monomers.

Particularly suitable monomers are methyl acrylate, ethyl acrylate, propyl acrylate, n-butyl acrylate, isobutyl acrylate, tert-butyl acrylate, 2-ethylhexyl acrylate, decyl acrylate, benzyl acrylate, benzyl methacrylate, methyl methacrylate, ethyl methacrylate, propyl methacrylate, n-butyl methacrylate, isobutyl methacrylate, tert-butyl methacrylate, 2-ethylhexyl methacrylate, decyl methacrylate, methyl ethacrylate, ethyl ethacrylate, n-butyl ethacrylate, isobutyl ethacrylate, tert-butyl ethacrylate, 2-ethylhexyl ethacrylate, decyl ethacrylate, 2,3-dihydroxypropyl acrylate, 2,3-dihydroxypropyl methacrylate, 2-hydroxyethyl acrylate, hydroxypropyl acrylates, 2-hydroxyethyl methacrylate, 2-hydroxyethyl ethacrylate, 2-methoxyethyl acrylate, 2-methoxyethyl methacylate, 2-methoxyethyl ethacrylate, 2-ethoxyethyl methacrylate, 2-ethoxyethyl ethacrylate, hydroxypropyl-methacrylates, glyceryl monoacrylate, glyceryl monomethacrylate, polyalkylene glycol (meth)acrylates, unsaturated sulfonic acids, vinyl ethers (for example: methyl, ethyl, butyl, or dodecyl vinyl ether), methyl vinyl ketone, vinylfuran, styrene, alpha-methylstyrene, meta-methylstyrene, para-methylstyrene, methylstyrene isomer mixtures, tert-butylstyrene, vinyltoluene, styrene sulfonate and mixtures thereof.

In the context of the invention, the examples of monomers A may account for example, for from 2 to 50% by weight or preferably from 5 to 30% by weight based on the total amount.

In addition to the abovementioned monomers, so-called macromonomers, such as, for example, ether-containing macromonomers having one or more groups capable of free radical polymerization or alkyloxazoline macromonomers, can be used as monomers, as descried, for example, in EP-A-408 311.

Furthermore, fluorine-containing monomers, as described, for example, in EP-B-558 423, can be used in combination or alone as crosslinking compounds or compounds which regulate the molecular weight.

Regulators which may be used are the customary compounds known to a person skilled in the art, such as, for example, sulfur compounds, (e.g., mercaptoethanol 2-ethylhexyl thioglycolate, thioglycolic acid or dodecyl mercaptan) and tribromochloromethane or other compounds which have a regulating effect on the molecular weight of the polymers obtained. Ether compounds containing thiol groups may optionally also be used. However, ether-free regulators are preferably used or the synthesis conditions are established so that no regulators have to be used.

Crosslinking monomers which may be used are compounds having at least two ethylenically unsaturated double bonds, such as, for example, esters of ethylenically unsaturated carboxylic acids, such as acrylic acid or methacrylic acid, and polyhydric alcohols, ethers of at least dihydric alcohols, such as, for example, vinyl ether or allyl ether. Also suitable are straight-chain or branched, linear or cyclic aliphatic or aromatic hydrocarbons, which however carry at least two double bonds which are not permitted to be conjugated in the case of the aliphatic hydrocarbons. Further suitable crosslinking agents are divinyldioxane, tetraallylsilane or tetravinylsilane.

Particularly preferred crosslinking agents are, for example, reaction products of polyhydric alcohols with acrylic acid or methacrylic acid, methacrylates and acrylates of polyalkylene oxides or polyhydric alcohols that have been reacted with ethylene oxide and/or propylene oxide and/or epichlorohydrin. As is familiar to one skilled in the art, however, the molecular weights can be adjusted so that no crosslinking agents are necessary.

The graft polymerization is initiated by free radical initiators, such as organic peroxides, e.g., dibenzoyl peroxide, diacetyl peroxide, dilauroyl peroxide, by azo structures, such as, for example, azobisisobutyronitrile, or by any other substance which thermally liberates free radicals. Redox systems, such as, for example, dibenzoyl peroxide/benzoin, may also be used. Furthermore, activation by irradiation is also suitable.

The initiators employed in the invention are preferably used in amounts of from about 0.01 to 10 percent by weight, preferably from 0.1 to 3%, based on the total amount of polyethers and monomers.

A multiplicity of suitable polyether derivatives B is available. Particularly suitable polyether derivatives B are polyoxyalkylene copolymers of the general formula II
(F)_{q}(O(C₂H_{4-d}R′_{d}O)ₘ(CₓH₂ₓO)ᵣZ)_{w} Formula II
having the meanings
d from 1 to 3,
m >1,
q 0 or 1,
x from 2 to 10,
r >1,
w from 1 to 4,
F a straight-chain or branched hydrocarbon radical,
R′ a hydrogen atom or a monovalent hydrocarbon radical having 1 to 18 C atoms, and
Z a hydrogen atom or a monovalent organic radical, in particular an alkyl, alkyl ester or aryl ester.

The polyethers described in the formula II are obtained by reaction of water or of an initiator alcohol, which is preferably an alcohol amine, alcohol or amine, by an addition reaction of monomers. Initiator alcohols may be, for example, 2-aminoethanol, ethylene glycol, propylene glycol, glycerol, oligo- and polyglycerols, 1,3-dihydroxypropane, 1,4-dihydroxybutane, 1,6-dihydroxyhexane, 1,2,4-trihydroxybutane, 1,2,6-trihydroxyhexane, 1,1,1-trimethylolpropane, pentaerythritol oligomers of pentaerythritol, polycaprolactone, xylitol, arabitol, sorbitol, mannitol, ethylenediamine, ammonia, 1,2,3,4-tetrahydroxybutane, castor oil or fructose.

Suitable monomers are ethylene oxide, propylene oxide, and compounds from the group consisting of tetrahydrofuran, 1,2-epoxybutane (n-butylene oxide), 2,3-epoxybutane (isobutylene oxide) and dodecyl oxide. The distribution of the monomers may be arbitrarily chosen so that, for example, blocks may be present. In addition, it is also possible to use a mixture of the monomers so that polyethers in which the units are present in random distribution are obtained.

Grafting processes known to one skilled in the art are used. The products obtained according to the invention were subjected to testing of applications in a polyurethane foam formulation. The products prepared according to the invention were compared with commercially used foam stabilizers based on polyether block copolymers.

The grafted polyether copolymers described are particularly preferably used as a stabilizer for rigid polyurethane foams in concentrations of from 0.01 to 20%, more preferably in concentrations of from 0.5 to 5% by weight based on the total amount of the starting materials of the grafting reaction.

The particular advantage of the invention manifests itself in the improvement of the flame retardance and/or reduction of the thermal conductivity of the polyurethane foam. These advantages will become more apparent in the following examples.

The following examples are intended to illustrate the invention but do not constitute any limitation at all.

### COMPARATIVE EXAMPLE 1

(Not According to the Invention):

Ethylene oxide/propylene oxide-containing block copolymer (MW approximately 5400, 40% proportion of EO), prepared according to the prior art 45 g of n-butanediol and 7 g of potassium methanolate were initially introduced into a pressure reactor and heated to 100° C. Thereafter, 3240 g of propylene oxide and then 2160 g of ethylene oxide were metered in over several hours and the reaction was continued for a further hour at 100° C. After cooling to 80° C., the reaction mixture was neutralized and filled.

### COMPARATIVE EXAMPLE 2

(Not According to the Invention):

Ethylene oxide/propylene oxide-containing block copolymer (MW=6500, 50% proportion of EO), prepared according to the prior art. 1 mol of H₂O and KOH were initially introduced into a pressure reactor and heated to 100° C. Thereafter 3240 g of propylene oxide were metered in over several hours and, after the subsequent reaction time of 1 h, 2160 g of ethylene oxide were metered in over several hours. After a further subsequent reaction time of 1 h at 100° C. and cooling to 80° C., the reaction mixture was neutralized and filled.

### COMPARATIVE EXAMPLE 3

(Not According to the Invention):

Ethylene oxide/butylene oxide-containing block copolymer (MW=6100, 40% proportion of EO), prepared analogously to comparative example 1.

Examples According to the Invention:

### EXAMPLE 1

Reaction of an ethylene oxide/propylene oxide-containing copolymer of comparative example 1 with styrene using Trigonox 117 as an initiator.

100 g of the ethylene oxide/propylene oxide-containing copolymer were heated to 140° C. in a four-necked flask, equipped with stirrer, jacketed coil condenser, thermometer and dropping funnel, under a nitrogen atmosphere. On reaching the temperature, 30 g of styrene and 1.8 g of Trigonox 117 were added dropwise in the course of 20 minutes, an exothermic reaction was observed. The reaction mixture was then kept at 150° C. for one hour. Thereafter, residual monomers were distilled off at 145° C. and under an oil pump vacuum using a distillation bridge. A yellowish, homogenous product was obtained.

### EXAMPLE 2

Reaction of an ethylene oxide/propylene oxide-containing copolymer of comparative example 1 with methyl methacrylate using Trigonox 117 as an initiator.

100 g of the ethylene oxide/propylene oxide-containing copolymer were heated to 140° C. in a four-necked flask, equipped with stirrer, jacketed coil condenser, thermometer and dropping funnel, under a nitrogen atmosphere. On reaching the temperature, 20 g of methyl methacrylate and 1.8 g of Trigonox 117 were added dropwise in the course of 20 minutes, an exothermic reaction being observed. The reaction mixture was then kept at 150° C. for one hour. Thereafter, residual monomers were distilled off at 145° C. and under an oil pump vacuum using a distillation bridge. A yellowish, homogenous product was obtained.

### EXAMPLE 3

Reaction of an ethylene oxide/propylene oxide-containing copolymer of comparative example 1 with butyl methacrylate using Trigonox 117 as an initiator.

100 g of the ethylene oxide/propylene oxide-containing copolymer were heated to 140° C. in a four-necked flask, equipped with stirrer, jacketed coil condenser, thermometer and dropping funnel, under a nitrogen atmosphere. On reaching the temperature, 20 g of butyl methacrylate and 1.8 g of Trigonox 117 were added dropwise in the course of 20 minutes, an exothermic reaction was observed. The reaction mixture was then kept at 150° C. for one hour. The residual monomers were distilled off at 145° C. and under an oil pump vacuum using a distillation bridge. A yellowish, homogenous product was obtained.

### EXAMPLE 4

Reaction of an ethylene oxide/propylene oxide-containing copolymer of comparative example 1 with cyclohexyl methacrylate using Trigonox 117 as an initiator.

100 g of the ethylene oxide/propylene oxide-containing copolymer were heated to 140° C. in a four-necked flask equipped with stirrer, jacketed coil condenser, thermometer and dropping funnel under a nitrogen atmosphere. On reaching the temperature, 20 g of cyclohexyl methacrylate and 1.8 g of Trigonox 117 were added dropwise in the course of 20 minutes, an exothermic reaction was observed. The reaction mixture was then kept at 150° C. for one hour. Thereafter, residual monomers were distilled off at 145° C. and under an oil pump vacuum using a distillation bridge. A yellowish, homogenous product was obtained.

### EXAMPLE 5

Reaction of an ethylene oxide/propylene oxide-containing copolymer of comparative example 2 with butyl methacrylate using Trigonox 117 as an initiator.

100 g of the ethylene oxide/propylene oxide-containing copolymer were heated to 140° C. in a four-necked flask, equipped with stirrer, jacketed coil condenser, thermometer and dropping funnel, under a nitrogen atmosphere. On reaching the temperature, 20 g of butyl methacylate and 1.8 g of Trigonox 117 were added dropwise in the course of 20 minutes, an exothermic reaction was observed. The reaction mixture was then kept at 150° C. for one hour. Thereafter, residual monomers were distilled off at 145° C. and under an oil pump vacuum using a distillation bridge. A yellowish, homogenous product was obtained.

### EXAMPLE 6

Reaction of an ethylene oxide/propylene oxide-containing copolymer of comparative example 3 with styrene using Trigonox 117 as an initiator.

100 g of the ethylene oxide/propylene oxide-containing copolymer were heated to 140° C. in a four-necked flask, equipped with stirrer, jacketed coil condenser, thermometer and dropping funnel, under a nitrogen atmosphere. On reaching the temperature, 20 g of styrene and 1.8 g of Trigonox 117 were added dropwise in the course of 20 minutes, an exothermic reaction was observed. The reaction mixture was then kept at 150° C. for one hour. Thereafter, residual monomers were distilled off at 145° C. and under an oil pump vacuum using a distillation bridge. A yellowish, homogenous product was obtained.

### EXAMPLE 7

Reaction of an ethylene oxide/propylene oxide-containing copolymer of comparative example 2 with methylstyrene using Trigonox 117 as an initiator.

100 g of the ethylene oxide/propylene oxide-containing copolymer were heated to 140° C. in a four-necked flask, equipped with stirrer, jacketed coil condenser, thermometer and dropping funnel, under a nitrogen atmosphere. On reaching the temperature, 20 g of methylstyrene and 1.8 g of Trigonox 117 were added dropwise in the course of 20 minutes, an exothermic reaction was observed. The reaction mixture was then kept at 150° C. for one hour. Thereafter, residual monomers were distilled off at 145° C. and under an oil pump vacuum using a distillation bridge. A yellowish, homogenous product was obtained.

For the following comparison, rigid polyurethane foams were produced in a 50×50×5 cm closable metallic mold heated to 45° C. by manual foaming of a polyurethane formulation comprising the following constituents:

| | | |
|---|---|---|
| 100.00 | pphp | of modified aromatic polyester polyol (230 mg KOH/g) |
| 3.00 | pphp | of KOSMOS ® 75 (Degussa) |
| 1.00 | pphp | of KOSMOS ® 33 (Degussa) |
| 2.50 | pphp | of TEGOAMIN ® DMEA (Degussa) |
| 0.70 | pphp | of water |
| 2.00 | pphp | of foam stabilizer |
| 15.00 | pphp | of tris(2-chloroisopropyl)phosphate |
| 17.00 | pphp | of n-pentane |
| 194.50 | pphp | of diphenylmethane diisocyanate, isomers and homologs |
| | | (isocyanate content: 31.5%) |

The rigid foams obtained were investigated by means of a visual assessment with regard to the surface characteristics, internal defects and cell fineness. Furthermore, the average thermal conductivity (K factor) was determined by thermal conductivity measurement with the aid of a heat flow measurement in a temperature gradient (36° C./10° C.).

The results which have been obtained with the polyether copolymers according to the invention are compared below with those of commercially available silicon-free emulsifiers.

| | Surface | Surface | | | Thermal |
|---|---|---|---|---|---|
| | defects | defects | Internal | Cell | conductivity |
| Stabilizer | - bottom - | - top - | defects | fineness | [mW/mK] |
| Example 1 | moderate | weak | moderate | very fine | 24.0 |
| Example 2 | moderate | weak | Weak | extremely | 23.6 |
| | | | | fine | |
| Example 3 | weak | weak | moderate | very fine | 24.1 |
| Example 4 | moderate | weak | Weak | very fine | 24.2 |
| Example 5 | weak | weak | moderate | very fine | 24.5 |
| Example 6 | weak | weak | Weak | extremely | 23.1 |
| | | | | fine | |
| Example 7 | moderate | weak | Weak | extremely | 23.6 |
| | | | | fine | |
| Comparative | very | strong | Strong | very fine | 25.2 |
| Example 1 | strong | | | | |
| Comparative | very | strong | Strong | fine | 25.7 |
| Example 2 | strong | | | | |
| Comparative | moderate | weak | moderate | very fine | 24.7 |
| Example 3 | | | | | |

As is evident from the above table the claimed compounds are suitable as foam stabilizers for the preparation of rigid foams and, in contrast to the more weakly stabilizing polyethers of comparative examples, are characterized by substantially fewer foam defects. Examples 1 to 7 illustrate the high stabilization potential of these organic stabilizes, which manifests itself in a smaller extent of foam defects close to the surface and internal defects of the test specimens obtained. Furthermore, in relation to the comparative examples, the rigid foams of these examples show finer cell structures which lead to significantly improved thermal conductivities.

While the invention has been described herein with reference to specific embodiments, features and aspects, it will be recognized that the invention is not thus limited, but rather extends in utility to other modifications, variations, applications, and embodiments, and accordingly all such other modifications, variations, applications, and embodiments are to be regarded as being within the spirit and scope of the invention.

What is claimed is:

1. A method of stabilizing a polyurethane (PU) and/or polyisocyanurate (PU) foam comprising foaming a formulation comprising reactants capable of forming at least one of PU and PI in the presence of a substantially silicon-free polymer obtainable by free radical graft polymerization of up to 50 parts by weight of at least one ethylenically unsaturated monomer (A) in the presence of at least 50 parts by weight of at least one polyether (B).

2. The method as claimed in claim 1, wherein said monomer A is selected from the group consisting of derivatives of acrylic acid and methacrylic acid, vinyl ethers, vinyl alcohols, vinyl esters, styrene, derivatives of styrene and mixture of these monomers.

3. The method as claimed in claim 2, wherein said monomer A is selected from the derivatives of acrylic acid and methacrylic acid of the general formula I
R¹O—C(O)CR²═CHR³
in which
R¹ is a C₁-C₄₀-linear, C₃-C₄₀-branched, aromatic or C₃-C₄₀-carbocyclic, optionally mono- or poly-hydroxyl-substituted hydrocarbon radical, and
R² and R³ independently of one another, are selected from the group consisting of: —H, C₁-C₈-linear or branched alkyl chains and the methoxy, ethoxy, 2-hydroxyethoxy, 2-methoxyethoxy and 2-ethoxyethyl group.

4. The method as claimed in claim 2, wherein said monomer A is selected from the group consisting of styrene, methylstyrene, tert-butylstyrene and other styrene derivatives and from mixtures of these monomers.

5. The method as claimed in claim 2, wherein said monomer A is selected from the group consisting of vinyl and allyl esters of C₁-C₄₀-linear, C₃-C₄₀-branched or C₃-C₄₀-carbocyclic carboxylic acids, and vinyl or allyl halides and mixtures of these monomers.

6. The method as claimed claim 1, wherein the polyether component B is a polyoxyalkylene copolymer of the general formula II
(F)_{q}(O(C₂H_{4-d}R′_{d}O)ₘ(CₓH₂ₓO)ᵣZ)_{w}
having the meaning
d from 1 to 3,
m >1,
q 0 or 1,
x from 2 to 10,
r >1,
w from 1 to 4,
F a straight-chain or branched hydrocarbon radical,
R′ a hydrogen atom or a monovalent hydrocarbon radical having 1 to 18 C atoms, and
Z a hydrogen atom or a monovalent organic radical.

7. The method as claimed in claim 1 wherein said substantially silicon-free polymer is present in a concentration of from 0.01 to 20%.

8. The method as claimed in claim 1 wherein said reactants form at least one of rigid PU and PI.

9. The method as claimed in claim 1 wherein said foamed PU and/or PI has improved flame retardance, reduced thermal conductivity or both as compared to a foamed PU and/or PI product not containing said substantially free silicon polymer which is obtainable by free radical graft polymerization of up to 50 parts by weight of at least one ethylenically unsaturated monomer (A) in the presence of at least 50 parts by weight of at least one polyether (B).

10. A foamed product comprising:
at least one of polyurethane (PU) and polyisocyanurate (PU); and
0.01 to 20% of a substantially free silicon polymer which is obtainable by free radical graft polymerization of up to 50 parts by weight of at least one ethylenically unsaturated monomer (A) in the presence of at least 50 parts by weight of at least one polyether (B).

11. The foamed product as claimed in claim 10, wherein said monomer A is selected from the group consisting of derivatives of acrylic acid and methacrylic acid, vinyl ethers, vinyl alcohols, vinyl esters, styrene, derivatives of styrene and mixture of these monomers.

12. The foamed product as claimed in claim 11, wherein said monomer A is selected from the derivatives of acrylic acid and methacrylic acid of the general formula I
R¹O—C(O)CR²═CHR³
in which
R¹ is a C₁-C₄₀-linear, C₃-C_{4O}-branched, aromatic or C₃-C₄₀-carbocyclic, optionally mono- or poly-hydroxyl-substituted hydrocarbon radical, and
R² and R³ independently of one another, are selected from the group consisting of: —H, C₁-C₈-linear or branched alkyl chains and the methoxy, ethoxy, 2-hydroxyethoxy, 2-methoxyethoxy and 2-ethoxyethyl group.

13. The foamed product as claimed in claim 11, wherein said monomer A is selected from the group consisting of styrene, methylstyrene, tert-butylstyrene and other styrene derivatives and from mixtures of these monomers.

14. The foamed product as claimed in claim 11, wherein said monomer A is selected from the group consisting of vinyl and allyl esters of C₁-C₄₀-linear, C₃-C₄₀-branched or C₃-C₄₀-carbocyclic carboxylic acids, and vinyl or allyl halides and mixtures of these monomers.

15. The foamed product as claimed claim 10, wherein the polyether component B is a polyoxyalkylene copolymer of the general formula II
(F)_{q}(O(C₂H_{4-d}R′_{d}O)ₘ(CₓH₂ₓO)ᵣZ)_{w}
having the meaning
d from 1 to 3,
m >1,
q 0 or 1,
x from 2 to 10,
r >1,
w from 1 to 4,
F a straight-chain or blanched hydrocarbon radical,
R′ a hydrogen atom or a monovalent hydrocarbon radical having 1 to 18 C atoms, and
Z a hydrogen atom or a monovalent organic radical.
